(19) United States
(12) Patent Application Publication
(10) Pub. No.: US 2020/0017762 A1
(43) Pub. Date: Jan. 16, 2020

(54) WAVELENGTH CONVERSION MATERIAL, BACKLIGHT UNIT, IMAGE DISPLAY DEVICE, AND CURABLE COMPOSITION

(71) Applicant: HITACHI CHEMICAL COMPANY, LTD., Tokyo (JP)

(72) Inventors: Yoichiro MANSEI, Tokyo (JP); Yoshitaka KATSUTA, Tokyo (JP); Eiji KOBAYASHI, Tokyo (JP); Kazuhiro YOSHIDA, Tokyo (JP); Tomomi KAWAMURA, Tokyo (JP); Tomoyuki NAKAMURA, Tokyo (JP); Masayuki WADA, Tokyo (JP); Tomohiro HORINOUCHI, Tokyo (JP); Kohei MUKAIGAITO, Tokyo (JP); Shigeaki FUNYU, Tokyo (JP); Takahiro TANABE, Tokyo (JP)

(73) Assignee: Hitachi Chemical Company, Ltd., Tokyo (JP)

(21) Appl. No.: 16/335,724

(22) PCT Filed: Sep. 26, 2017
(86) PCT No.: PCT/JP2017/034811

§ 371 Date: Mar. 22, 2019

(30) Foreign Application Priority Data
Sep. 26, 2016 (JP) PCT/JP2016/078276

(51) Int. Cl. C09K 11/02; C09K 11/88; C09K 11/56; C08F 220/14; C08F 236/22; C08F 220/18; C08J 5/18; C08F 220/68; F21V 8/00

(52) U.S. Cl. CPC C09K 11/02; C09K 11/883; C09K 11/565; C08F 220/14; C08F 236/22; C08J 2333/08; C08J 5/18; C08F 220/68; G02B 6/005; C08J 2333/10; C08J 2347/00; C08F 220/18

(57) ABSTRACT

A wavelength conversion material contains a cured product of a curable composition that contains a (meth)allyl compound, a (meth)acryl compound, a photopolymerization initiator, and a quantum dot phosphor.

### TECHNICAL FIELD

The present invention relates to a wavelength conversion material, a backlight unit, an image display device, and a curable composition.

### BACKGROUND ART

In recent years, in the field of image display devices such as liquid crystal displays, improvement in color reproducibility of displays is required. As means for improving the color reproducibility, attention has been drawn to wavelength conversion materials including quantum dot phosphors (see, for example, Patent Documents 1 and 2).

A wavelength conversion material including a quantum dot phosphor is arranged, for example, in a backlight unit of an image display device. In the case of using a wavelength conversion material including a quantum dot phosphor that emits red light and a quantum dot phosphor that emits green light, when blue light serving as excitation light is irradiated to the wavelength conversion material, white light can be obtained by the red light and the green light emitted from the quantum dot phosphors and the blue light transmitted through the wavelength conversion material. Due to the development of wavelength conversion materials including a quantum dot phosphor, the color reproducibility of displays has increased from conventional 72% of national television system committee (NTSC) to 100% of NTSC.

A wavelength conversion material containing a quantum dot phosphor usually has a cured product obtained by curing a curable composition containing a quantum dot phosphor. The curable composition includes a thermosetting type and a light curing type, and from the viewpoint of productivity, a light curing type curable composition is preferably used.

### PRIOR ART DOCUMENT

### Patent Documents

Patent Document 1: Japanese Patent Application Laid-Open (JP-A) No. 2013-544018

Patent Document 2: International Publication No. WO 2016/052625

### SUMMARY OF INVENTION

### Technical Problem

Meanwhile, in the wavelength conversion material containing a quantum dot phosphor, at least a part of a cured product including a quantum dot phosphor is covered with a coating material in some cases. For example, in the case of a film-like wavelength conversion material, a barrier film having barrier properties against at least one of oxygen and water is provided on one side or both sides of a cured product layer containing a quantum dot phosphor in some cases.

In such a case, adhesion between a cured product containing a quantum dot phosphor and a coating material is important. In a case in which the adhesion between a cured product containing a quantum dot phosphor and a coating material is not sufficient, for example, the coating material may be peeled off when a wavelength conversion material is cut into a prescribed size (for example, punched out by a punching machine).

However, compared to a thermosetting type curable composition, a light curing type curable composition containing a quantum dot phosphor tended to deteriorate adhesion between a cured product containing a quantum dot phosphor and a coating material.

Accordingly, the disclosure provides a curable composition containing a quantum dot phosphor and having excellent adhesion of a cured product therefrom, and a wavelength conversion material, a backlight unit, and an image display device using the curable composition.

### Means for Solving the Problems

A specific means for solving the above-described problems includes the following embodiments.

<1> A wavelength conversion material containing a cured product of a curable composition that contains a (meth)allyl compound, a (meth)acryl compound, a photopolymerization initiator, and a quantum dot phosphor.

<2> The wavelength conversion material according to claim 1, in which the curable composition further contains a thiol compound.

<3> The wavelength conversion material according to claim 1 or 2, in which the (meth)acryl compound includes a monofunctional(meth)acryl compound.

<4> The wavelength conversion material according to claim 3, in which the monofunctional (meth)acryl compound includes an alkyl (meth)acrylate having an alkyl group having from 1 to 18 carbon atoms.

<5> The wavelength conversion material according to claim 4, in which the alkyl (meth)acrylate having an alkyl group having from 1 to 18 carbon atoms includes at least one selected from the group consisting of methyl (meth)acrylate, n-butyl (meth)acrylate, isobutyl (meth)acrylate, 2-ethylhexyl (meth)acrylate, isononyl (meth)acrylate, n-octyl (meth)acrylate, lauryl (meth)acrylate, and stearyl (meth)acrylate.

<6> The wavelength conversion material according to any one of claims 3 to 5, in which the monofunctional (meth)acryl compound includes an alicyclic (meth)acrylate compound.

<7> The wavelength conversion material according to claim 6, in which the alicyclic (meth)acrylate compound includes at least one selected from the group consisting of cyclohexyl (meth)acrylate, dicyclopentanyl (meth)acrylate, isobornyl (meth)acrylate, and methylene oxide adduct cyclodecatriene (meth)acrylate.

<8> The wavelength conversion material according to claim 1 or 2, in which the (meth)acryl compound includes a monofunctional methacrylate compound.

<9> The wavelength conversion material according to any one of claims 1 to 8, in which the quantum dot phosphor contains a compound containing at least one of Cd or In.

<10> The wavelength conversion material according to any one of claims 1 to 9, in which the cured product is in a form of a film.

<11> The wavelength conversion material according to any one of claims 1 to 10, further containing a coating material that coats at least a portion of the cured product.

<12> The wavelength conversion material according to claim 11, in which the coating material has barrier properties against at least one of oxygen or water.

<13> The wavelength conversion material according to any one of claims 1 to 12, in which a loss tangent (tan 6) of the cured product measured under conditions of a frequency of 10 Hz and a temperature of 25° C. by dynamic viscoelasticity measurement is from 0.4 to 1.5.

<14> A backlight unit containing the wavelength conversion material according to any one of claims 1 to 13 and a light source.

<15> An image display device containing the backlight unit according to claim 14.

<16> A curable composition containing a (meth)allyl compound, a (meth)acryl compound, a photopolymerization initiator, and a quantum dot phosphor.

<17> The curable composition according to claim 16, further containing a thiol compound.

<18> The curable composition according to claim 16 or 17, in which the (meth)acryl compound includes a monofunctional (meth)acryl compound.

<19> The curable composition according to claim 18, in which the monofunctional (meth)acryl compound includes an alkyl (meth)acrylate having an alkyl group having from 1 to 18 carbon atoms.

<20> The curable composition according to claim 19, in which the alkyl (meth)acrylate having an alkyl group having from 1 to 18 carbon atoms includes at least one selected from the group consisting of methyl (meth)acrylate, n-butyl (meth)acrylate, isobutyl (meth)acrylate, 2-ethylhexyl (meth)acrylate, isononyl (meth)acrylate, n-octyl (meth)acrylate, lauryl (meth)acrylate, and stearyl (meth)acrylate.

<21> The curable composition according to any one of claims 18 to 20, in which the monofunctional (meth)acryl compound includes an alicyclic (meth)acrylate compound.

<22> The curable composition according to claim 21, in which the alicyclic (meth)acrylate compound includes at least one selected from the group consisting of cyclohexyl (meth)acrylate, dicyclopentanyl (meth)acrylate, isobornyl (meth)acrylate, and methylene oxide adduct cyclodecatriene (meth)acrylate.

<23> The curable composition according to claim 16 or 17, in which the (meth)acryl compound includes a monofunctional methacrylate compound.

<24> The curable composition according to any one of claims 16 to 23, in which the quantum dot phosphorcontains a compound containing at least one of Cd or In.

### Advantageous Effects of Invention

According to the disclosure, a curable composition containing a quantum dot phosphor and having excellent adhesion of a cured product therefrom, and a wavelength conversion material, a backlight unit, and an image display device using the curable composition can be provided.

### BRIEF DESCRIPTION OF DRAWINGS

FIG. 1 is a schematic sectional view illustrating an example of a schematic configuration of a wavelength conversion material according to the present embodiment.

FIG. 2 is a diagram showing an example of a schematic configuration of a backlight unit according to the present embodiment.

FIG. 3 is a diagram showing an example of a schematic configuration of a liquid crystal display in the present embodiment.

### DESCRIPTION OF EMBODIMENTS

Hereinafter, embodiments of the present invention will be described in detail.

However, the present invention is not limited to the following embodiments. In the following embodiments, the constituent elements (including the element steps and the like) are not indispensable except when particularly explicitly mentioned. The same applies to numerical values and ranges thereof, and does not limit the present invention.

In the present specification, each numerical range specified using “(from) . . . to . . . ” represents a range including the numerical values noted before and after “to” as the minimum value and the maximum value, respectively.

In the present specification, with respect to numerical ranges stated hierarchically herein, the upper limit or the lower limit of a numerical range of a hierarchical level may be replaced with the upper limit or the lower limit of a numerical range of another hierarchical level. Further, in the present specification, with respect to a numerical range, the upper limit or the lower limit of the numerical range may be replaced with a relevant value shown in any of Examples.

In the present specification, each component may include plural kinds of substances corresponding to the component. In a case in which plural kinds of substances exist corresponding to a component in the composition, the content means, unless otherwise specified, a total amount of the plural kinds of substances existing in the composition.

In the present specification, the term “layer” comprehends herein not only a case in which the layer is formed over the whole observed region where the layer is present, but also a case in which the layer is formed only on part of the region.

In the present specification, the term “layered” as used herein indicates “provided on or above”, in which two or more layers may be bonded or detachable.

In the present specification, the term “process” denotes not only independent processes but also processes that cannot be clearly distinguished from other processes as long as a purpose is accomplished by the process.

In the present specification, (meth)allyl means allyl or methallyl, (meth)acryl means acryl or methacryl, (meth) acryloyl means acryloyl or methacryloyl, and (meth)acrylate means acrylate or methacrylate.

<Curable Composition>

The curable composition in the present embodiment contains a (meth)allyl compound, a (meth)acryl compound, a photopolymerization initiator, and a quantum dot phosphor. The curable composition in the present embodiment may further contain another component such as a thiol compound described below, if necessary. By having the above configuration, the curable composition in the present embodiment has excellent adhesion when a cured product is produced from the curable composition.

The (meth)allyl compound means a compound having a (meth)allyl group in the molecule, and the (meth)acryl compound means a compound having a (meth)acryloyl group in the molecule. Compounds having both (meth)allyl group and (meth)acryloyl group in the molecule are classified as (meth)allyl compounds for convenience.

Hereinafter, components contained in the curable composition in the present embodiment will be described in detail.

((Meth)allyl Compound)

The curable composition in the present embodiment contains a (meth)allyl compound. The (meth)allyl compound may be a monofunctional (meth)allyl compound having one (meth)allyl group in one molecule or a polyfunctional (meth)allyl compound having two or more (meth)allyl groups in one molecule. From the viewpoint of further improving adhesion of a cured product, it is preferable that the (meth)allyl compound contains a polyfunctional (meth)allyl compound. A ratio of the polyfunctional (meth)allyl compound to a total amount of the (meth)allyl compound is preferably, for example, 80% by mass or more, more preferably 90% by mass or more, and still more preferably 100% by mass.

Specific examples of the monofunctional (meth)allyl compound include (meth)allyl acetate, (meth)allyl n-propionate, (meth)allyl benzoate, (meth)allyl phenylacetate, (meth)allyl phenoxyacetate, (meth)allyl methyl ether, and (meth)allyl glycidyl ether.

Specific examples of the polyfunctional (meth)allyl compound include benzenedicarboxylic acid di(meth)allyl, cyclohexanedicarboxylic acid di(meth)allyl, di(meth)allyl maleate, di(meth)allyl adipate, di(meth)allyl phthalate, di(meth)allyl isophthalate, di(meth)allyl terephthalate, glycerin di(meth)allyl ether, trimethylolpropane di(meth)allyl ether, pentaerythritol di(meth)allyl ether, 1,3-di(meth)allyl-5-glycidyl isocyanurate, tri(meth)allyl cyanurate, tri(meth)allyl isocyanurate, tri(meth)allyl trimellitate, tetra(meth)allyl pyromellitate, 1,3,4,6-tetra(meth)allyl glycoluril, 1,3,4,6-tetra(meth)allyl-3a-methyl glycoluril, and 1,3,4,6-tetra(meth)allyl-3a,6a-dimethyl glycoluril.

The curable composition in the present embodiment may contain one kind of (meth)allyl compound singly, or may contain two or more kinds of (meth)allyl compounds in combination.

As the (meth)allyl compound, at least one selected from the group consisting of tri(meth)allyl cyanurate, tri(meth)allyl isocyanurate, benzenedicarboxylic acid di(meth)allyl, and cyclohexanedicarboxylic acid di(meth)allyl is preferable, and tri(meth)allyl isocyanurate is more preferable from the viewpoints of heat resistance and moist heat resistance of a cured product.

A content of a (meth)allyl compound in a curable composition is preferably, for example, based on the total amount of the curable composition, from 10% by mass to 50% by mass, more preferably from 15% by mass to 45% by mass, and still more preferably from 20% by mass to 40% by mass. In a case in which the content of the (meth)allyl compound is 10% by mass or more, the heat resistance and moist heat resistance of the cured product tend to be further improved, and in a case in which the content of the (meth)allyl compound is 50% by mass or less, the adhesion of the cured product tends to be further improved.

((Meth)acryl Compound)

The curable composition in the present embodiment contains a (meth)acryl compound. The (meth)acryl compound may be a monofunctional (meth)acryl compound having one (meth)acryloyl group in one molecule or a polyfunctional (meth)acryl compound having two or more (meth)acryloyl groups in one molecule. From the viewpoint of further improving storage stability of a curable composition and adhesion of a cured product, it is preferable that the (meth)acryl compound contains a monofunctional (meth)acryl compound. A ratio of the monofunctional (meth)acryl compound to a total amount of the (meth)acryl compound is preferably, for example, 80% by mass or more, more preferably 90% by mass or more, and still more preferably 100% by mass.

Examples of monofunctional (meth)acryl compounds include (meth)acrylic acid; an alkyl (meth)acrylate having an alkyl group having from 1 to 18 carbon atoms such as methyl (meth)acrylate, n-butyl (meth)acrylate, isobutyl (meth)acrylate, 2-ethylhexyl (meth)acrylate, isononyl (meth)acrylate, n-octyl (meth)acrylate, lauryl (meth)acrylate, or stearyl (meth)acrylate; a (meth)acrylate compound having an aromatic ring such as benzyl (meth)acrylate or phenoxyethyl (meth)acrylate; an alkoxyalkyl (meth)acrylate such as butoxyethyl (meth)acrylate; an aminoalkyl (meth)acrylate such as N,N-dimethylaminoethyl (meth)acrylate; a polyalkylene glycol monoalkyl ether (meth)acrylate such as diethylene glycol monoethyl ether (meth)acrylate, triethylene glycol monobutyl ether (meth)acrylate, tetraethylene glycol monomethyl ether (meth)acrylate, hexaethylene glycol monomethyl ether (meth)acrylate, octaethylene glycol monomethyl ether (meth)acrylate, nonaethylene glycol monomethyl ether (meth)acrylate, dipropylene glycol monomethyl ether (meth)acrylate, heptapropylene glycol monomethyl ether (meth)acrylate, or tetraethylene glycol monoethyl ether (meth)acrylate; a polyalkylene glycol monoaryl ether (meth)acrylate such as hexaethylene glycol monophenyl ether (meth)acrylate; an alicyclic (meth)acrylate compound such as cyclohexyl (meth)acrylate, dicyclopentanyl (meth)acrylate, isobornyl (meth)acrylate, or methylene oxide adduct cyclodecatriene (meth)acrylate; a heterocyclic (meth)acrylate compound such as (meth)acryloyl morpholine or tetrahydrofurfuryl (meth)acrylate; a fluoroalkyl (meth)acrylate such as heptadecafluorodecyl (meth)acrylate; a (meth)acrylate compound having a hydroxyl group such as 2-hydroxyethyl (meth)acrylate, 3-hydroxypropyl (meth)acrylate, 4-hydroxybutyl (meth)acrylate, triethylene glycol mono (meth)acrylate, tetraethylene glycol mono (meth)acrylate, hexaethylene glycol mono (meth)acrylate, or octapropylene glycol mono (meth)acrylate; a (meth)acrylate compound having a glycidyl group such as glycidyl (meth)acrylate; a (meth)acrylate compound having an isocyanate group such as 2-(2-(meth)acryloyloxyethyloxy)ethyl isocyanate or 2-(meth)acryloyloxyethyl isocyanate; a polyalkylene glycol mono (meth)acrylate such as tetraethylene glycol mono (meth)acrylate, hexaethylene glycol mono (meth)acrylate, or octapropylene glycol mono (meth)acrylate; and a (meth)acrylamide compound such as (meth)acrylamide, N,N-dimethyl (meth)acrylamide, N-isopropyl (meth)acrylamide, N,N-dimethylaminopropyl (meth)acrylamide, N,N-diethyl (meth)acrylamide, or 2-hydroxyethyl (meth)acrylamide.

Specific examples of polyfunctional (meth)acrylic compounds include an alkylene glycol di(meth)acrylate such as 1,4-butanediol di(meth)acrylate, 1,6-hexanediol di(meth)acrylate, or 1,9-nonanediol di(meth)acrylate; a polyalkylene glycol di(meth)acrylate such as polyethylene glycol di(meth)acrylate or polypropylene glycol di(meth)acrylate; a tri(meth)acrylate compound such as trimethylolpropane tri(meth)acrylate, ethylene oxide-adduct trimethylolpropane tri(meth)acrylate, or tris(2-hydroxyethyl) isocyanurate tri(meth)acrylate (also known as tris(2-(meth)acryloyloxyethyl) isocyanurate); and a tetra(meth)acrylate compound such as ethylene oxide-adduct pentaerythritol tetra(meth)acrylate, trimethylolpropane tetra(meth)acrylate, or pentaerythritol tetra(meth)acrylate.

The curable composition in the present embodiment may contain one kind of (meth)acryl compound singly, or may contain two or more kinds of (meth)acryl compounds in combination.

In a case in which the (meth)acryl compound include a monofunctional (meth)acryl compound, the monofunctional (meth)acryl compound may include an alkyl (meth)acrylate having an alkyl group having from 1 to 18 carbon atoms.

In the alkyl (meth)acrylate in which the alkyl group has from 1 to 18 carbon atoms, the number of carbon atoms of the alkyl group is preferably from 4 to 16, and more preferably from 8 to 14.

The alkyl (meth)acrylate having an alkyl group having from 1 to 18 carbon atoms may contain at least one selected from the group consisting of methyl (meth)acrylate, n-butyl (meth)acrylate, isobutyl (meth)acrylate, 2-ethylhexyl (meth)acrylate, isononyl (meth)acrylate, n-octyl (meth)acrylate, lauryl (meth)acrylate, and stearyl (meth)acrylate.

In a case in which the (meth)acryl compound include a monofunctional (meth)acryl compound, examples of the monofunctional (meth)acryl compound may include an alicyclic (meth)acrylate compound.

The alicyclic (meth)acrylate compound may include at least one selected from the group consisting of cyclohexyl (meth)acrylate, dicyclopentanyl (meth)acrylate, isobornyl (meth)acrylate, and methylene oxide adduct cyclodecatriene (meth)acrylate.

From the viewpoint of further improving the heat resistance and moist heat resistance of a cured product, the (meth)acryl compound is preferably an alicyclic monofunctional (meth)acrylate compound, and more preferably isobornyl (meth)acrylate. From the viewpoint of further improving the storage stability of a curable composition, the (meth)acryl compound is preferably a monofunctional methacrylate compound. One example of a particularly preferable (meth)acryl compound is isobornyl methacrylate.

A content of a (meth)acryl compound in the curable composition based on the total amount of the curable composition is, for example, preferably 1% by mass to 50% by mass, more preferably from 5% by mass to 40% by mass, and still more preferably from 10% by mass to 30% by mass. In a case in which the content of the (meth)acryl compound is 1% by mass or more, the storage stability of the curable composition and the adhesion of a cured product tend to be further improved, and in a case in which the content of the (meth)acryl compound is 50% by mass or less, the heat resistance and moist heat resistance of a cured product tend to be improved.

(Photopolymerization Initiator)

The curable composition in the present embodiment contains a photopolymerization initiator.

The photopolymerization initiator is not particularly limited, and examples thereof include compounds that generate radicals upon irradiation with active energy rays such as ultraviolet rays.

Specific examples of the photopolymerization initiator include an aromatic ketone compound such as benzophenone, N,N′-tetraalkyl-4,4′-diaminobenzophenone, 2-benzyl-2-dimethylamino-1-(4-morpholinophenyl)-butanone-1,2-methyl-1-[4-(methylthio)phenyl]-2-morpholino-propanone-1,4,4′-bis(dimethylamino)benzophenone (also referred to as “Michler's ketone”), 4,4′-bis(diethylamino)benzophenone, 4-methoxy-4′-dimethyl aminobenzophenone, 1-hydroxycyclohexyl phenyl ketone, 1-(4-isopropylphenyl)-2-hydroxy-2-methylpropan-1-one, 1-(4-(2-hydroxyethoxy)-phenyl)-2-hydroxy-2-methyl-1-propan-1-one, 2-hydroxy-2-methyl-1-phenylpropan-1-one; a quinone compound such as alkylanthraquinone or phenanthrenequinone; a benzoin compound such as benzoin or alkylbenzoin; a benzoin ether compound such as benzoin alkyl ether or benzoin phenyl ether; a benzyl derivative such as benzyl dimethyl ketal; 2,4,5-triarylimidazole dimer such as 2-(o-chlorophenyl)-4,5-diphenylimidazole dimer, 2-(o-chlorophenyl)-4,5-di(m-methoxyphenyl)imidazole dimer, 2-(o-fluorophenyl)-4,5-diphenylimidazole dimer, 2-(o-methoxyphenyl)-4,5-diphenylimidazole dimer, 2,4-di(p-methoxyphenyl)-5-phenylimidazole dimer, or 2-(2,4-dimethoxyphenyl)-4,5-diphenylimidazole dimer; an acridine derivative such as 9-phenylacridine or 1,7-(9,9′-acridinyl)heptane; an oxime ester compound such as 1,2-octanedione 1-[4-(phenylthio)-2-(O-benzoyloxime)], ethanone 1-[9-ethyl-6-(2-methylbenzoyl)-9H-carbazol-3-yl]-1-(O-acetyloxime); a coumarin compound such as 7-diethylamino-4-methylcoumarin; a thioxanthone compound such as 2,4-diethylthioxanthone; and an acylphosphine oxide compound such as 2,4,6-trimethylbenzoyl-diphenyl-phosphine oxide or 2,4,6-trimethylbenzoyl-phenyl-ethoxy-phosphine oxide. The curable composition in the present embodiment may contain one kind of photopolymerization initiator singly or may contain two or more kinds of photopolymerization initiators in combination.

From the viewpoint of curability, the photopolymerization initiator is preferably at least one selected from the group consisting of an acylphosphine oxide compound, an aromatic ketone compound, and an oxime ester compound, more preferably at least one selected from the group consisting of an acylphosphine oxide compound and an aromatic ketone compound, and still more preferably an acylphosphine oxide compound.

A content of a photopolymerization initiator in the curable composition is preferably, for example, based on the total amount of the curable composition, from 0.1% by mass to 5% by mass, more preferably from 0.1% by mass to 3% by mass, and more preferably from 0.5% by mass to 1.5% by mass. In a case in which the content of the photopolymerization initiator is 0.1% by mass or more, the sensitivity of the curable composition tends to be sufficient, and in a case in which the content of the photopolymerization initiator is 5% by mass or less, influences on the hue of the curable composition and deterioration in the storage stability tend to be suppressed.

(Quantum Dot Phosphor)

The curable composition in the present embodiment contains a quantum dot phosphor. The quantum dot phosphor is not particularly limited, and examples thereof include particles including at least one selected from the group consisting of a group II-VI compound, a group III-V compound, a group IV-VI compound, and a group IV compound. From the viewpoint of luminous efficiency, the quantum dot phosphor preferably contains a compound containing at least one of Cd or In.

Specific examples of the group II-VI compound include CdSe, CdTe, CdS, ZnS, ZnSe, ZnTe, ZnO, HgS, HgSe, HgTe, CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, CdZnSeS, CdZnSeTe, CdZnSTe, CdHgSeS, CdHgSeTe, CdHgSTe, HgZnSeS, HgZnSeTe, and HgZnSTe.

Specific examples of the group III-V compound include GaN, GaP, GaAs, GaSb, AlP, AlAs, AlSb, InN, InP, InAs, InSb, GaNP, GaNAs, GaNSb, GaPAs, GaPSb, AlNP, AlNAs, AlNSb, AlPAs, AlPSb, InNP, InNAs, InNSb, InPAs, InPSb, GaAlNP, GaAlNAs, GaAlNSb, GaAlPAs, GaAlPSb, GaInNP, GaInNAs, GaInNSb, GaInPAs, GaInPSb, InAlNP, InAlNAs, InAlNSb, InAlPAs, and InAlPSb.

Specific examples of the group IV-VI compound include SnS, SnSe, SnTe, PbS, PbSe, PbTe, SnSeS, SnSeTe, SnSTe, PbSeS, PbSeTe, PbSTe, SnPbS, SnPbSe, SnPbTe, SnPbSSe, SnPbSeTe, and SnPbSTe.

Specific examples of the group IV compound include Si, Ge, SiC, and SiGe.

As the quantum dot phosphor, one having a core-shell structure is preferable. By making the band gap of the compound constituting the shell wider than the band gap of the compound constituting the core, quantum efficiency of the quantum dot phosphor can be further improved. Examples of the core/shell combination (core/shell) include CdSe/ZnS, InP/ZnS, PbSe/PbS, CdSe/CdS, CdTe/CdS, and CdTe/ZnS.

The quantum dot phosphor may have a so-called core-multishell structure in which the shell has a multilayer structure. By layering one or two or more shells having a narrow band gap on a core having a wide band gap and further layering on the shell a shell having a wide band gap, it is possible to further improve the quantum efficiency of the quantum dot phosphor.

The curable composition in the present embodiment may contain one kind of quantum dot phosphor singly, or may contain two or more kinds of quantum dot phosphor in combination. Examples of an aspect in which two or more kinds of quantum dot phosphors are contained in combination include an aspect in which two or more kinds of quantum dot phosphors which have different components but have the same average particle size are contained, an aspect in which two or more kinds of quantum dot phosphors that have different average particle sizes but have the same component are contained, and an aspect in which two or more kinds of quantum dot phosphors having different components and average particle sizes are contained. By changing at least one of the components and the average particle size of the quantum dot phosphor, the emission center wavelength of the quantum dot phosphor can be changed.

For example, the curable composition in the present embodiment may contain a quantum dot phosphor G having an emission center wavelength in a green wavelength region of from 520 nm to 560 nm and a quantum dot phosphor R having a emission center wavelength in a red wavelength region of from 600 nm to 680 nm. In a case in which a cured product of a curable composition containing a quantum dot phosphor G and a quantum dot phosphor R is irradiated with excitation light in a blue wavelength region of from 430 nm to 480 nm, green light and red light are emitted from the quantum dot phosphor G and the quantum dot phosphor R, respectively. As a result, white light can be obtained from the green light and the red light emitted from the quantum dot phosphor G and the quantum dot phosphor R and blue light passing through the cured product.

A content of the quantum dot phosphor in a curable composition is preferably, for example, based on the total amount of the curable composition, from 1% by mass to 10% by mass, more preferably from 4% by mass to 10% by mass, and still more preferably from 4% by mass to 7% by mass. In a case in which the content of the quantum dot phosphor is 1% by mass or more, sufficient emission intensity tends to be obtained when a cured product is irradiated with excitation light, and in a case in which the content of the quantum dot phosphor is 10% by mass or less, aggregation of the quantum dot phosphor tends to be suppressed.

(Thiol Compound)

The curable composition in the present embodiment may further contain a thiol compound. In a case in which the curable composition further contains a thiol compound, an enthiol reaction proceeds between a (meth)allyl compound and a thiol compound when the curable composition is cured, and adhesion of a cured product tends to be further improved. In a case in which the curable composition further contains a thiol compound, optical properties of a cured product tend to be further improved.

Although a composition containing a (meth)allyl compound and a thiol compound is often inferior in storage stability, the storage stability of the curable composition in the present embodiment is excellent even when the curable composition in the present embodiment further contains a thiol compound. This is presumably because the curable composition in the present embodiment contains a (meth)acryl compound.

The thiol compound may be a monofunctional thiol compound having one thiol group in one molecule or a polyfunctional thiol compound having two or more thiol groups in one molecule. From the viewpoint of further improving the adhesion, heat resistance, and moist heat resistance of a cured product, examples of the thiol compound preferably include a polyfunctional thiol compound. A ratio of the polyfunctional thiol compound to a total amount of the thiol compound is, for example, preferably 80% by mass or more, more preferably 90% by mass or more, and still more preferably 100% by mass.

Specific examples of the monofunctional thiol compound include hexanethiol, 1-heptanethiol, 1-octanethiol, 1-nonanethiol, 1-decanethiol, 3-mercaptopropionic acid, methyl mercaptopropionate, methoxybutyl mercaptopropionate, octyl mercaptopropionate, tridecyl mercaptopropionate, 2-ethylhexyl-3-mercaptopropionate, and n-octyl-3-mercaptopropionate.

Specific examples of the polyfunctional thiol compound include ethylene glycol bis(3-mercaptopropionate), diethylene glycol bis(3-mercaptopropionate), tetraethylene glycol bis(3-mercaptopropionate), 1,2-propylene glycol bis(3-mercaptopropionate), diethyl ene glycol bis(3-mercaptobutyrate), 1,4-butanediol bis(3-mercaptopropionate), 1,4-butanediol bis(3-mercaptobutyrate), 1,8-octanediol bis(3-mercaptopropionate), 1,8-octanediol bis(3-mercaptobutyrate), hexanediol bisthioglycolate, trimethylolpropane tris(3-mercaptopropionate), trimethylolpropane tris(3-mercaptobutyrate), trimethylolpropane tris(3-mercaptoisobutyrate), trimethylolpropane tris(2-mercaptoisobutyrate), trimethylolpropane tris thioglycolate, tris-[(3-mercaptopropionyloxy)-ethyl]-isocyanurate, trimethylol ethane tris(3-mercaptobutyrate), pentaerythritol tetrakis(3-mercaptopropionate), pentaerythritol tetrakis(3-mercaptobutyrate), pentaerythritol tetrakis(3-mercaptoisobutyrate), pentaerythritol tetrakis(2-mercaptoisobutyrate), dipentaerythritol hexakis(3-mercaptopropionate), dipentaerythritol hexakis(2-mercaptopropionate), dipentaerythritol hexakis(3-mercaptobutyrate), dipentaerythritol hexakis(3-mercaptoisobutyrate), dipentaerythritol hexakis(2-mercaptoisobutyrate), pentaerythritol tetrakis thioglycolate, and dipentaerythritol hexakis thioglycolate.

The multifunctional thiol compound may be in the form of a thioether oligomer reacted with a polyfunctional (meth) acrylic compound in advance.

The thioether oligomer can be obtained by addition polymerization of a polyfunctional thiol compound and a polyfunctional (meth)acryl compound in the presence of a polymerization initiator. A ratio (equivalent number of thiol group/equivalent number of (meth)acryloyl group) of an equivalent number of thiol groups of the polyfunctional thiol compound to an equivalent number of (meth)acryloyl groups of the polyfunctional (meth)acryl compound is, for example, preferably from 3.0 to 3.3, more preferably from 3.0 to 3.2, and still more preferably from 3.05 to 3.15.

The weight average molecular weight of the thioether oligomer is, for example, preferably from 3,000 to 10,000, more preferably from 3,000 to 8,000, and still more preferably from 4,000 to 6,000.

The weight average molecular weight of the thioether oligomer can be obtained by converting from a molecular weight distribution measured by gel permeation chromatography (GPC) by using a calibration curve of standard polystyrene as shown in Examples described below.

The thiol equivalent of the thioether oligomer is, for example, preferably from 200 g/eq to 400 g/eq, more preferably from 250 g/eq to 350 g/eq, and still more preferably from 250 g/eq to 270 g/eq.

The thiol equivalent of the thioether oligomer can be measured by an iodine titration method as described below.

0.2 g of a measurement sample is precisely weighed, and 20 mL of chloroform is added thereto to prepare a sample solution. As a starch indicator, a solution prepared by dissolving 0.275 g of soluble starch in 30 g of pure water is used. 20 mL of pure water, 10 mL of isopropyl alcohol, and 1 mL of a starch indicator are added to the sample solution, and the mixture is stirred with a stirrer. An iodine solution is added dropwise, and the end point is a point where a chloroform layer appears green. At this time, a value given by the following formula is taken as a thiol equivalent of the measurement sample.

Thiol equivalent (g/eq)=mass of measurement sample (g)×10,000/titer of iodine solution (mL)×factor of iodine solution

Among thioether oligomers, a thioether oligomer obtained by addition polymerization of pentaerythritol tetrakis(3-mercaptopropionate) and tris(2-hydroxyethyl)isocyanurate triacrylate (also known as tris(2-acryloyloxyethyl)isocyanurate) is preferable from the viewpoint of further improving optical properties, heat resistance, and moist heat resistance of a cured product.

In a case in which the curable composition contains a thiol compound, a content of the thiol compound in the curable composition is, for example, based on the total amount of the curable composition, preferably from 40% by mass to 80% by mass, more preferably from 50% by mass to 80% by mass, and still more preferably from 50% by mass to 70% by mass. In a case in which the content of the thiol compound is 40% by mass or more, adhesion of a cured product tends to be further improved, and in a case in which the content of the thiol compound is 80% by mass or less, the heat resistance and moist heat resistance of a cured product tend to be further improved.

(Liquid Medium)

The curable composition in the present embodiment may further contain a liquid medium. The liquid medium is a medium in a liquid state at room temperature (25° C.).

Examples of the liquid medium include: a ketone solvent such as acetone, methyl ethyl ketone, methyl-n-propyl ketone, methyl isopropyl ketone, methyl-n-butyl ketone, methyl isobutyl ketone, methyl-n-pentyl ketone, methyl-n-hexyl ketone, diethyl ketone, dipropyl ketone, diisobutyl ketone, trimethylnonane, cyclohexanone, cyclopentanone, methyl cyclohexanone, 2,4-pentanedione, or acetonylacetone; an ether solvent such as diethyl ether, methyl ethyl ether, methyl-n-propyl ether, diisopropyl ether, tetrahydrofuran, methyl tetrahydrofuran, dioxane, dimethyl dioxane, ethylene glycol dimethyl ether, ethylene glycol diethyl ether, ethylene glycol di-n-propyl ether, ethylene glycol di-n-butyl ether, diethylene glycol dimethyl ether, diethylene glycol diethyl ether, diethylene glycol methyl ethyl ether, diethylene glycol methyl-n-propyl ether, diethylene glycol methyl-n-butyl ether, diethylene glycol di-n-propyl ether, diethylene glycol di-n-butyl ether, diethylene glycol methyl-n-hexyl ether, triethylene glycol dimethyl ether, triethylene glycol diethyl ether, triethylene glycol methyl ethyl ether, triethylene glycol methyl n-butyl ether, triethylene glycol di-n-butyl ether, triethylene glycol methyl-n-hexyl ether, tetraethylene glycol dimethyl ether, tetraethylene glycol diethyl ether, tetraethylene glycol methyl ethyl ether, tetraethylene glycol methyl-n-butyl ether, tetraethylene glycol di-n-butyl ether, tetraethylene glycol methyl-n-hexyl ether, propylene glycol dimethyl ether, propylene glycol diethyl ether, propylene glycol di-n-propyl ether, propylene glycol di-n-butyl ether, dipropylene glycol dimethyl ether, dipropylene glycol diethyl ether, dipropylene glycol methyl ethyl ether, dipropylene glycol methyl-n-butyl ether, dipropylene glycol di-n-propyl ether, dipropylene glycol di-n-butyl ether, dipropylene glycol methyl-n-hexyl ether, tripropylene glycol dimethyl ether, tripropylene glycol diethyl ether, tripropylene glycol methyl ethyl ether, tripropylene glycol methyl-n-butyl ether, tripropylene glycol di-n-butyl ether, tripropylene glycol methyl-n-hexyl ether, tetrapropylene glycol dimethyl ether, tetrapropylene glycol diethyl ether, tetrapropylene glycol methyl ethyl ether, tetrapropylene glycol methyl-n-butyl ether, tetrapropylene glycol di-n-butyl ether, or tetrapropylene glycol methyl-n-hexyl ether; a carbonate solvent such as propylene carbonate, ethylene carbonate, or diethyl carbonate; an ester solvent such as methyl acetate, ethyl acetate, n-propyl acetate, isopropyl acetate, n-butyl acetate, isobutyl acetate, sec-butyl acetate, n-pentyl acetate, sec-pentyl acetate, 3-methoxybutyl acetate, methyl pentyl acetate, 2-ethylbutyl acetate, 2-ethylhexyl acetate, 2-(2-butoxyethoxy)ethyl acetate, benzyl acetate, cyclohexyl acetate, methyl cyclohexyl acetate, nonyl acetate, methyl acetoacetate, ethyl acetoacetate, diethylene glycol methyl ether acetate, diethylene glycol monoethyl ether acetate, dipropylene glycol methyl ether acetate, dipropylene glycol ethyl ether acetate, glycol diacetate, methoxytriethylene glycol acetate, ethyl propionate, n-butyl propionate, isoamyl propionate, diethyl oxalate, di-n-butyl oxalate, methyl lactate, ethyl lactate, n-butyl lactate, n-amyl lactate, ethylene glycol methyl ether propionate, ethylene glycol ethyl ether propionate, ethylene glycol methyl ether acetate, ethylene glycol ethyl ether acetate, propylene glycol methyl ether acetate, propylene glycol ethyl ether acetate, propylene glycol propyl ether acetate, y-butyrolactone, or y-valerolactone; an aprotic polar solvent such as acetonitrile, N-methyl pyrrolidinone, N-ethyl pyrrolidinone, N-propyl pyrrolidinone, N-butyl pyrrolidinone, N-hexyl pyrrolidinone, N-cyclohexyl pyrrolidinone, N,N-dimethylformamide, N,N-dimethylacetamide, or dimethyl sulfoxide; an alcohol solvent such as methanol, ethanol, n-propanol, isopropanol, n-butanol, isobutanol, sec-butanol, t-butanol, n-pentanol, isopentanol, 2-methylbutanol, sec-pentanol, t-pentanol, 3-methoxybutanol, n-hexanol, 2-methylpentanol, sec-hexanol, 2-ethylbutanol, sec-heptanol, n-octanol, 2-ethylhexanol, sec-octanol, n-nonyl alcohol, n-decanol, sec-undecyl alcohol, trimethyl nonyl alcohol, sec-tetradecyl alcohol, sec-heptadecyl alcohol, cyclohexanol, methyl cyclohexanol, benzyl alcohol, ethylene glycol, 1,2-propylene glycol, 1,3-butylene glycol, diethylene glycol, dipropylene glycol, triethylene glycol, or tripropylene glycol; a glycol monoether solvent such as ethylene glycol monomethyl ether, ethylene glycol monoethyl ether, ethylene glycol monophenyl ether, diethylene glycol monomethyl ether, diethylene glycol monoethyl ether, diethylene glycol mono-n-butyl ether, diethylene glycol mono-n-hexyl ether, triethylene glycol monoethyl ether, tetraethylene glycol mono-n-butyl ether, propylene glycol monomethyl ether, dipropylene glycol monomethyl ether, dipropylene glycol monoethyl ether, or tripropylene glycol monomethyl ether; a terpene solvent such as terpinene, terpineol, myrcene, alloocimene, limonene, dipentene, pinene, carvone, ocimene, or phellandrene; a straight silicone oil such as dimethyl silicone oil, methyl phenyl silicone oil, or methyl hydrogen silicone oil; a modified silicone oil such as an amino-modified silicone oil, an epoxy-modified silicone oil, a carboxy-modified silicone oil, a carbinol-modified silicone oil, a mercapto-modified silicone oil, a heterogeneous functional group-modified silicone oil, a polyether-modified silicone oil, a methylstyryl-modified silicone oil, a hydrophilic special modified silicone oil, a higher alkoxy-modified silicone oil, a higher fatty acid-modified silicone oil, or a fluorine-modified silicone oil; a saturated aliphatic monocarboxylic acid having 4 or more carbon atoms such as butanoic acid, pentanoic acid, hexanoic acid, heptanoic acid, octanoic acid, nonanoic acid, decanoic acid, undecanoic acid, dodecanoic acid, tridecanoic acid, tetradecanoic acid, pentadecanoic acid, hexadecanoic acid, heptadecanoic acid, octadecanoic acid, nonadecanoic acid, icosanoic acid, or eicosenoic acid; and an unsaturated aliphatic monocarboxylic acid having 8 or more carbon atoms such as oleic acid, elaidic acid, linoleic acid, or palmitoleic acid. The curable composition in the present embodiment may contain one kind of liquid medium singly, or two or more kinds of liquid media in combination.

In a case in which the curable composition contains a liquid medium, a content of the liquid medium in the curable composition based on the total amount of the curable composition is, for example, preferably from 1% by mass to 10% by mass, more preferably from 4% by mass to 10% by mass, and still more preferably from 4% by mass to 7% by mass.

(Other Components)

The curable composition in the present embodiment may further contain another component such as a polymerization inhibitor, a silane coupling agent, a surfactant, an adhesion promoter, or an antioxidant. For each of the other components, one kind of the curable composition in the present embodiment may be contained singly, or two or more kinds thereof may be contained in combination.

(Method of Preparing Curable Composition)

The curable composition in the present embodiment can be prepared by mixing a (meth)allyl compound, a (meth)acryl compound, a photopolymerization initiator, a quantum dot phosphor, and, if necessary, another component such as a thiol compound or a liquid medium by a normal method. It is preferable that the quantum dot phosphor is mixed in a state of being dispersed in a liquid medium.

<Wavelength Conversion Material>

The wavelength conversion material in the present embodiment includes a cured product of the above-described curable composition in the present embodiment. The wavelength conversion material in the present embodiment may further include another constituent material such as a coating material described below, if necessary.

The shape of a cured product is not particularly limited, and examples thereof include a film shape and a lens shape. In a case in which the cured product is applied to a backlight unit described below, the cured product is preferably in a form of a film.

In a case in which a cured product is in a form of a film, an average thickness of the cured product is, for example, preferably from 50 μm to 200 μm, more preferably from 50 μm to 150 μm, and still more preferably from 80 μm to 120 μm. In a case in which the average thickness is 50 μm or more, the wavelength conversion efficiency tends to be further improved, and in a case in which the average thickness is 200 μm or less, a thinner backlight unit tends to be formed in a case in which the cured product is applied to a backlight unit described below.

The average thickness of a film-like cured product can be obtained as, for example, an arithmetic mean value of thicknesses of arbitrary three places measured using a micrometer.

The cured product may be one obtained by curing one curable composition or may be one obtained by curing two or more curable compositions. For example, in a case in which the cured product is in a form of a film, the cured product may be one obtained by layering a first cured product layer obtained by curing a curable composition containing a first quantum dot phosphor and a second cured product layer obtained by curing a curable composition containing a second quantum dot phosphor having a light emitting property different from that of the first quantum dot phosphor.

The cured product can be obtained by forming a coating film, a molded body or the like of the curable composition, and drying if necessary, and then being irradiated with an active energy ray such as an ultraviolet ray. The wavelength and irradiation amount of the active energy ray can be appropriately set according to the composition of the curable composition. In one aspect, ultraviolet light having a wavelength of from 280 nm to 400 nm is irradiated at an irradiation dose of from 100 mJ/cm² to 5,000 mJ/cm². Examples of the ultraviolet ray source include a low pressure mercury lamp, a medium pressure mercury lamp, a high pressure mercury lamp, a super high pressure mercury lamp, a carbon arc lamp, a metal halide lamp, a xenon lamp, a chemical lamp, a black light lamp, and a microwave excited mercury lamp.

From the viewpoint of further improving the adhesion, the cured product preferably has a loss tangent (tan 6) of from 0.4 to 1.5 measured by dynamic viscoelasticity measurement at a frequency of 10 Hz and a temperature of 25° C., more preferably from 0.4 to 1.2, and still more preferably from 0.4 to 0.6. The loss tangent (tan 6) of the cured product can be measured using a dynamic viscoelasticity measuring device (for example, Solid Analyzer RSA-III manufactured by Rheometric Scientific Inc.).

From the viewpoint of further improving adhesion, heat resistance, and moist heat resistance, the cured product preferably has a glass transition temperature (Tg) of from 10° C. to 40° C., more preferably from 25° C. to 40° C., still more preferably from 25° C. to 35° C., and particularly preferably from 30° C. to 35° C. The glass transition temperature (Tg) of the cured product can be measured using a dynamic viscoelasticity measuring device (for example Solid Analyzer RSA-III, manufactured by Rheometric Scientific Inc.).

From the viewpoint of further improving adhesion, heat resistance, and moist heat resistance, the cured product preferably has a storage modulus measured at a frequency of 10 Hz and a temperature of 25° C. of from 1×10⁷ Pa to 1×10⁹ Pa, more preferably from 5×10⁷ Pa to 1×10⁹ Pa, and still more preferably from 5×10⁷ Pa to 5×10⁸ Pa. The storage modulus of the cured product can be measured using a dynamic viscoelasticity measuring device (for example, Solid Analyzer RSA-III manufactured by Rheometric Scientific Inc.).

The wavelength conversion material in the present embodiment may be one in which at least a portion of the cured product is covered with a coating material. For example, in a case in which the cured product is in a form of a film, one side or both sides of the film-like cured product may be covered with a film-like coating material.

From the viewpoint of suppressing a decrease in luminous efficiency of the quantum dot phosphor, the coating material preferably has barrier properties against at least one of oxygen or water, and more preferably has barrier properties against both oxygen and water. The coating material having barrier properties against at least one of oxygen or water is not particularly limited, and a known coating material such as a barrier film having an inorganic layer can be used.

In a case in which the coating material is in a form of a film, an average thickness of the coating material is, for example, preferably from 100 μm to 150 μm, more preferably from 100 μm to 140 μm, and still more preferably from 100 μm to 135 μm. In a case in which the average thickness is 100 μm or more, functions such as barrier properties tend to be sufficient, and in a case in which the average thickness is 150 μm or less, a decrease in light transmittance tends to be suppressed.

The average thickness of the film-like coating material can be determined in the same manner as the film-like cured product.

An oxygen permeability of the coating material is, for example, preferably 0.5 mL/(m²·24 h·atm) or less, more preferably 0.3 mL/(m²·24 h·atm) or less, and still more preferably 0.1 mL/(m²·24 h·atm) or less. The oxygen permeability of the coating material can be measured under conditions of a temperature of 23° C. and a relative humidity of 65% using an oxygen permeability measuring device (for example, OX-TRAN manufactured by MOCON Inc.).

A water vapor permeability of the coating material is, for example, preferably 5×10⁻² g/(m²·24 h·Pa) or less, more preferably 1×10⁻² g/(m²·24 h·Pa) or less, and still more preferably 5×10⁻³ g/(m²·24 h·Pa) or less. The water vapor permeability of the coating material can be measured under conditions of a temperature of 40° C. and a relative humidity of 90% using a water vapor permeability measuring device (for example, AQUATRAN manufactured by MOCON Inc.).

From the viewpoint of further improving the light utilization efficiency, the wavelength conversion material in the present embodiment preferably has a total light transmittance of 55% or more, more preferably 60% or more, and still more preferably 65% or more. The total light transmittance of the wavelength conversion material can be measured in accordance with the measurement method of JIS K 7136: 2000.

From the viewpoint of further improving the light utilization efficiency, the wavelength conversion material in the present embodiment preferably has a haze of 95% or more, more preferably 97% or more, and still more preferably 99% or more. The haze of the wavelength conversion material can be measured according to the measurement method of JIS K 7136: 2000.

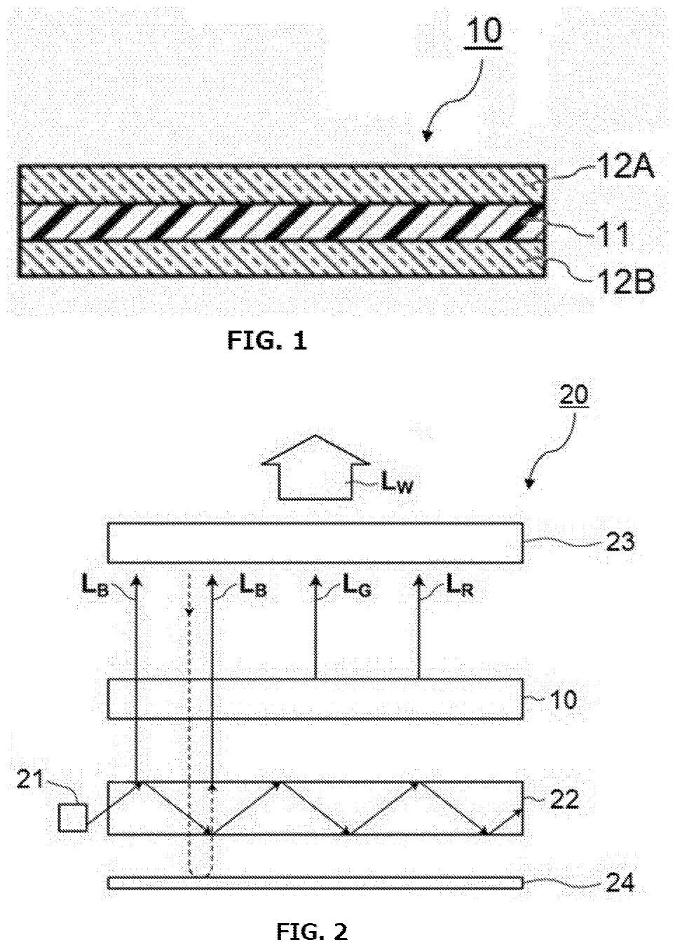

An example of a schematic configuration of the wavelength conversion material is shown in FIG. 1. The wavelength conversion material in the present embodiment is not limited to the configuration of FIG. 1. The sizes of the cured product layer and the coating material in FIG. 1 are conceptual, and the relative relationship of the sizes is not limited thereto. In the following drawings, the same reference numerals are assigned to the members having substantially the same functions, and redundant explanation may be omitted.

The wavelength conversion material 10 shown in FIG. 1 includes a cured product layer 11 which is a film-like cured product and film-like coating materials 12A and 12B provided on both sides of the cured product layer 11. The kinds and average thicknesses of the coating material 12A and the coating material 12B may be the same or different from each other.

The wavelength conversion material having the configuration shown in FIG. 1 can be manufactured, for example, by the following known manufacturing method.

First, a curable composition is applied to the surface of a film-like coating material to be continuously conveyed (hereinafter, also referred to as “first coating material”) to form a coating layer. The method of applying a curable composition is not particularly limited, and examples thereof include a die coating method, a curtain coating method, an extrusion coating method, a rod coating method, and a roll coating method.

Next, a film-like coating material to be continuously conveyed (hereinafter, also referred to as “second coating material”) is attached onto the coating layer of the curable composition.

Subsequently, by irradiating an active energy ray from a side of the first coating material and the second coating material, the side which can transmit active energy rays, the coating layer is cured to form a cured product layer. Then, by cutting out to a prescribed size, a wavelength conversion material having the configuration shown in FIG. 1 can be obtained.

In a case in which neither the first coating material nor the second coating material is capable of transmitting active energy rays, before attaching the second coating material, the coating layer may be irradiated with an active energy ray to form a cured product layer.

<Backlight Unit>

The backlight unit in the present embodiment includes the wavelength conversion material in the present embodiment described above and a light source.

From the viewpoint of improving color reproducibility, the backlight unit is preferably a multi-wavelength light source. One preferred embodiment is a backlight unit that emits blue light having an emission center wavelength in the wavelength range of from 430 nm to 480 nm and emission intensity peak having a half width of 100 nm or less, green light having an emission center wavelength in the wavelength range of from 520 nm to 560 nm and emission intensity peak having a half width of 100 nm or less, and red light having an emission center wavelength in the wavelength range of from 600 nm to 680 nm and emission intensity peak having a half width of 100 nm or less. The half width of the emission intensity peak means the peak width at a height of ½ the peak height.

From the viewpoint of further improving the color reproducibility, it is preferable that the emission center wavelength of the blue light emitted by the backlight unit is in the range of from 440 nm to 475 nm. From the same viewpoint, the emission center wavelength of the green light emitted by the backlight unit is preferably in the range of from 520 nm to 545 nm. From the same viewpoint, the emission center wavelength of the red light emitted by the backlight unit is preferably in the range of from 610 nm to 640 nm.

From the viewpoint of further improving the color reproducibility, the half width of each emission intensity peak of the blue light, the green light, and the red light emitted from the backlight unit is preferably 80 nm or less, more preferably 50 nm or less, still more preferably 40 nm or less, particularly preferably 30 nm or less, and extremely preferably 25 nm or less.

As a light source of the backlight unit, for example, a light source that emits blue light having an emission center wavelength in the wavelength range of from 430 nm to 480 nm can be used. Examples of the light source include an LED (Light Emitting Diode) and laser. In the case of using a light source that emits blue light, it is preferable that the wavelength conversion material includes at least a quantum dot phosphor R that emits red light and a quantum dot phosphor G that emits green light. As a result, white light can be obtained from the red light and the green light emitted from the wavelength conversion material and blue light transmitted through the wavelength conversion material.

As a light source of the backlight unit, for example, a light source that emits ultraviolet light having an emission center wavelength in the wavelength range of from 300 nm to 430 nm can be used. Examples of the light source include an LED and laser. In the case of using a light source that emits ultraviolet light, it is preferable that the wavelength conversion material includes the quantum dot phosphor R and the quantum dot phosphor and the quantum dot phosphor B excited by an excitation light to emit blue light. As a result, white light can be obtained by the red light, the green light, and the blue light emitted from the wavelength conversion material.

The backlight unit in the present embodiment may be of an edge-light type or a direct-light type.

An example of the schematic configuration of an edge-lit type backlight unit is shown in FIG. 2. The backlight unit in the present embodiment is not limited to the configuration of FIG. 2. The sizes of the members in FIG. 2 are conceptual, and the relative relationship between the sizes of the members is not limited thereto.

The backlight unit 20 shown in FIG. 2 includes a light source 21 for emitting blue light L_{B}, a light guide plate 22 for guiding and emitting the blue light L_{B} emitted from the light source 21, a wavelength conversion material 10 arranged opposite to the light guide plate 22, a retroreflective member 23 arranged opposite to the light guide plate 22 via the wavelength conversion material 10, and a reflection plate 24 arranged opposite to the wavelength conversion material 10 via the light guide plate 22. The wavelength conversion material 10 emits red light L_{R} and green light L_{G} with a part of the blue light L_{B} as excitation light, and emits the red light L_{R} and the green light L_{G}, and blue light L_{B} which did not become excitation light. By the red light L_{R}, the green light L_{G}, and the blue light L_{B}, white light L_{W} is emitted from the retroreflective member 23.

<Image Display Device>

The image display device in the present embodiment includes the above-described backlight unit in the present embodiment. The image display device is not particularly limited, and examples thereof include a liquid crystal display.

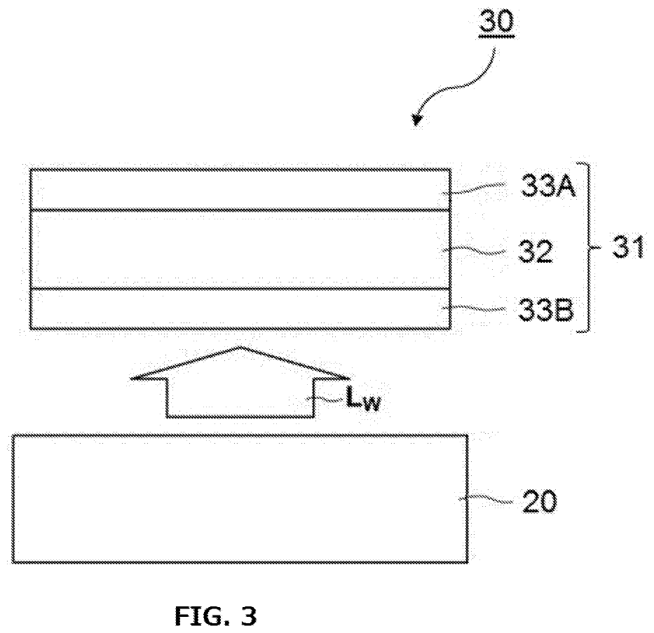

An example of the schematic configuration of a liquid crystal display is shown in FIG. 3. The liquid crystal display in the present embodiment is not limited to the configuration of FIG. 3. The sizes of the members in FIG. 3 are conceptual, and the relative relationship between the sizes of the members is not limited thereto.

The liquid crystal display 30 shown in FIG. 3 includes a backlight unit 20 and a liquid crystal cell unit 31 arranged opposite to the backlight unit 20. In the liquid crystal cell unit 31, a liquid crystal cell 32 is arranged between a polarizing plate 33A and a polarizing plate 33B.

The driving system of the liquid crystal cell 32 is not particularly limited, and examples thereof include a twisted nematic (TN) system, a super twisted nematic (STN) system, a vertical alignment (VA) system, an in-plane-switching (IPS) system, and an optically compensated birefringence (OCB) method.

### EXAMPLES

Hereinafter, the present invention will be specifically described with reference to Examples, but the invention is not limited to the Examples.

### Synthesis Example 1

Into a reaction vessel equipped with a thermometer, a stirrer, a nitrogen introduction tube, and vacuum piping, 174.0 g of pentaerythritol tetrakis(3-mercaptopropionate) (PEMP manufactured by SC Organic Chemical Industry Co., Ltd.) was placed, the interior of the reaction vessel was depressurized using a vacuum pump while stirring at a rotation speed of 200 rpm, and the vessel was held for 30 minutes. Thereafter, 26.0 g of tris(2-acryloyloxyethyl)isocyanurate (Funkryl FA-731A manufactured by Hitachi Chemical Company, Ltd.) which had been previously dissolved by heating at from 55° C. to 65° C. was added thereto, and the mixture was stirred for 30 minutes. Subsequently, 0.25 g of triethylamine was added thereto as a catalyst, and the mixture was reacted for 2 hours. Upon confirming that an absorption peak of an acryloyl group had disappeared by infrared spectroscopic analysis, the reaction was terminated, and a thioether oligomer (weight average molecular weight: 4,600) was obtained.

The weight average molecular weight is a value determined by conducting gel permeation chromatography under the following apparatus and measurement conditions and converting using a calibration curve of a standard polystyrene. For preparing the calibration curve, 5 sample sets (PStQUICK MP-H, PStQUICK B [trade name, manufactured by Tosoh Corporation]) were used as the standard polystyrene.

Apparatus: HIGH-SPEED GPC APPARATUS HLC-8320GPC (Detector: differential refractometer) (trade name, manufactured by Tosoh Corporation)

Solvent used: tetrahydrofuran (THF)

Column: COLUMN TSKGEL SUPERMULTIPORE HZ-H (trade name, manufactured by Tosoh Corporation)

Column size: column length 15 cm, column inner diameter 4.6 mm Measurement temperature: 40° C.

Flow rate: 0.35 mL/min

Sample concentration: 10 mg/5 mL THF

Injection volume: 20 μL

### Examples 1 to 7 and Comparative Examples 1 and 2

### (Prepare of Curable Composition)

The curable compositions of Examples 1 to 7 and Comparative Examples 1 and 2 were prepared by mixing each component shown in Table 1 at the blending amount (unit: part by mass) shown in the same table. “-” in Table 1 means not blended.

As the photopolymerization initiator, 2,4,6-trimethylbenzoyl-phenyl-ethoxy-phosphine oxide (IRGACURE TPO-L manufactured by BASF) was used. As the quantum dot phosphor, a CdSe/ZnS (core/shell) dispersion (Gen2 QD Concentrate manufactured by Nanosys Inc.) was used.

TABLE 1

| | | | | | | | | | Comparative | Comparative |
|---|---|---|---|---|---|---|---|---|---|---|
| Item | | Example 1 | Example 2 | Example 3 | Example 4 | Example 5 | Example 6 | Example 7 | Example 1 | Example 2 |
| (Meth)allyl | Triallyl | 20.0 | 20.0 | 20.0 | 20.0 | 20.0 | 20..0 | 20.0 | 40.0 | 30.0 |
| compound | isocyanurate | | | | | | | | | |
| (Meth)acryl | Isobornyl | 25.0 | 20.0 | 15.0 | 10.0 | — | — | — | — | — |
| compound | methacrylate | | | | | | | | | |
| | Isobornyl | — | — | — | — | 20.0 | — | — | — | — |
| | acrylate | | | | | | | | | |
| | Lauryl | — | — | — | — | — | 10.0 | 20.0 | — | — |
| | methacrylate | | | | | | | | | |
| Photopolymerization | TPO-L | 1.0 | 1.0 | 1.0 | 1.0 | 1.0 | 1.0 | 1.0 | 1.0 | 1.0 |
| initiator | | | | | | | | | | |
| Quantum dot | Gen 2 QD | 6.5 | 6.5 | 6.5 | 6.5 | 6.5 | 6.5 | 6.5 | 6.5 | 6.5 |
| phosphor dispersion | Concentrate | | | | | | | | | |
| Thiol compound | Thioether | 54.0 | 59.0 | 64.0 | 69.0 | 59.0 | 69.0 | 59.0 | 59.0 | 69.0 |
| | oligomer of | | | | | | | | | |
| | Synthesis | | | | | | | | | |
| | Example 1 | | | | | | | | | |

(Manufacturing of Wavelength Conversion Material)

Each curable composition obtained above was applied onto a barrier film having a thickness of 110 μm (manufactured by Toppan Printing Co., Ltd.) (coating material) to form a coating layer. A barrier film having a thickness of 110 μm (manufactured by Toppan Printing Co., Ltd.) (coating material) was attached onto the coating layer and irradiated with ultraviolet light (irradiation amount: 1,000 mJ/cm²) using an ultraviolet irradiation device (manufactured by Eye Graphics Co., Ltd.) to obtain wavelength conversion materials in which the covering material was disposed on both sides of the cured product layer.

<Evaluation>

Using the curable compositions and wavelength conversion materials obtained in Examples 1 to 7 and Comparative Examples 1 and 2, the following respective evaluation items were measured and evaluated. The results are shown in Table 2.

(Total Light Transmittance and Haze)

Each of the wavelength conversion materials obtained above was cut into a size of 50 mm in width and 50 mm in length to obtain an evaluation sample. Then, the total light transmittance and haze of the evaluation sample were measured using a turbidimeter (NHD-2000 manufactured by Nippon Denshoku Industries Co., Ltd.) in accordance with the measurement method of JIS K 7136:2000. The haze of the evaluation sample was obtained according to the following formula.

Haze (%)=(Td/Tt)×100
Td: diffuse transmittance
Tt: total light transmittance

(Adhesion)

Each wavelength conversion material obtained above was cut into a size of 25 mm in width and 100 mm in length, and then, a barrier film on one side was peeled off in the direction of 90 degrees under a temperature environment of 25° C. at a pulling rate of 300 mm/min using a tensile tester (RTC-1210 manufactured by ORIENTEC CORPORATION), and the peel strength was measured.

(Storage Stability)

Each of the curable compositions obtained above was stored for 24 hours under conditions of a temperature of 25° C. and a relative humidity of 50%, and the viscosity increase rate of the curable composition was measured according to the following formula.

Viscosity increase rate (%)=(Vb/Va)×100
Va: initial viscosity (mPa·s)
Vb: viscosity after 24 hours (mPa·s)

The storage stability of the curable composition was then evaluated according to the following evaluation criteria.

### —Evaluation Criteria—

A: viscosity increase rate: less than 150%
B: viscosity increase rate: from 150% to less than 200%
C: viscosity increase rate: 200% or more

(Storage Modulus, Loss Tangent, and Glass Transition Temperature)

The barrier film of the wavelength conversion material obtained above was peeled off, and cut into a size of 5 mm in width and 40 mm in length to obtain a cured product for evaluation. Then, by using a wide dynamic viscoelasticity measuring device (Solid Analyzer RSA-III manufactured by Rheometric Scientific Inc.), the storage modulus and the loss modulus of the cured product for evaluation at a temperature of 25° C. were measured under the condition of “tension mode, distance between chucks: 25 mm, frequency: 10 Hz, measurement temperature range: from −20° C. to 100° C., heating rate: 5° C./minute”, and the loss tangent (tan 6) was obtained from the ratio of the storage modulus and the loss modulus. The glass transition temperature (Tg) was determined from the temperature of a peak top of the loss tangent (tan 6).

(Flatness)

The barrier film of the wavelength conversion material obtained above was peeled off, and cut into a width of 200 mm and a length of 200 mm to obtain a cured product for evaluation. The cured product was placed on a flat table, and the heights of wrinkles generated at an end portion from the table were measured for all sides, and the flatness was evaluated by the total value.

### —Evaluation Criteria—

A: 1.0 mm or less
B: from 1.0 mm to 3.0 mm
C: 3.0 mm or more

TABLE 2

| | | | | | | | | Comparative | Comparative |
|---|---|---|---|---|---|---|---|---|---|
| Item | Example 1 | Example 2 | Example 3 | Example 4 | Example 5 | Example 6 | Example 7 | Example 1 | Example 2 |
| Total light | 66 | 67 | 65 | 65 | 73 | 66 | 65 | 60 | 62 |
| transmittance | | | | | | | | | |
| (%) | | | | | | | | | |
| Haze (%) | 99 | 99 | 99 | 99 | 99 | 99 | 99 | 99 | 99 |
| Peel strength | 4.5 | 6.0 | 8.0 | 13.5 | 7.9 | 15.0 | 13.0 | 0.9 | 1.3 |
| (N/25 mm) | | | | | | | | | |
| Storage | A | A | A | A | B | A | A | C | C |
| stability | | | | | | | | | |
| Storage | 4.1E+08 | 2.2E+08 | 7.9E+07 | 8.2E+07 | 4.0E+08 | 2.7E+0.7 | 5.2E+07 | 1.9E+09 | 1.2E+09 |
| modulus (Pa) | | | | | | | | | |
| Loss tangent | 0.4 | 0.6 | 1.2 | 1.3 | 0.4 | 1.4 | 1.2 | 0.03 | 0.07 |
| Glass | 35 | 33 | 31 | 27 | 35 | 14 | 20 | 64 | 45 |
| transition | | | | | | | | | |
| temperature | | | | | | | | | |
| (° C.) | | | | | | | | | |
| Flatness | A | A | A | A | A | A | A | C | B |

As can be seen from Table 2, the curable composition of Examples 1 to 7 containing a (meth)allyl compound, a (meth)acryl compound, a photopolymerization initiator, and a quantum dot phosphor had remarkably excellent adhesion of the cured product as compared with the curable compositions of Comparative Examples 1 and 2 which did not contain a (meth)acryl compound.

The entire contents of the disclosures by International Application No. PCT/JP2016/078276 filed on Sep. 26, 2016 are incorporated herein by reference.

All the literature, patent application, and technical standards cited herein are also herein incorporated to the same extent as provided for specifically and severally with respect to an individual literature, patent application, and technical standard to the effect that the same should be so incorporated by reference.

### REFERENCE SIGNS LIST

10 . . . wavelength conversion material
11 . . . cured product layer
12A . . . coating material
12B . . . coating material
20 . . . backlight unit
21 . . . light source
22 . . . light guide plate
23 . . . retroreflective member
24 . . . reflection plate
30 . . . liquid crystal display
31 . . . liquid crystal cell unit
32 . . . liquid crystal cell
33A . . . polarizing plate
33B . . . polarizing plate
L_{B} . . . blue light
L_{R} . . . red light
L_{G} . . . green light
L_{W} . . . white light

1. A wavelength conversion material comprising a cured product of a curable composition that contains a (meth)allyl compound, a (meth)acryl compound, a photopolymerization initiator, and a quantum dot phosphor.

2. The wavelength conversion material according to claim 1, wherein the curable composition further contains a thiol compound.

3. The wavelength conversion material according to claim 1, wherein the (meth)acryl compound includes a monofunctional (meth)acryl compound.

4. The wavelength conversion material according to claim 3, wherein the monofunctional (meth)acryl compound includes an alkyl (meth)acrylate having an alkyl group having from 1 to 18 carbon atoms.

5. The wavelength conversion material according to claim 4, wherein the alkyl (meth)acrylate having an alkyl group having from 1 to 18 carbon atoms includes at least one selected from the group consisting of methyl (meth)acrylate, n-butyl (meth)acrylate, isobutyl (meth)acrylate, 2-ethylhexyl (meth)acrylate, isononyl (meth)acrylate, n-octyl (meth)acrylate, lauryl (meth)acrylate and stearyl (meth)acrylate.

6. The wavelength conversion material according to claim 3, wherein the monofunctional (meth)acryl compound includes an alicyclic (meth)acrylate compound.

7. The wavelength conversion material according to claim 6, wherein the alicyclic (meth)acrylate compound includes at least one selected from the group consisting of cyclohexyl (meth) acrylate, dicyclopentanyl (meth)acrylate, isobornyl (meth)acrylate and methylene oxide adduct cyclodecatriene (meth) acrylate.

8. The wavelength conversion material according to claim 1, wherein the (meth)acryl compound includes a monofunctional methacrylate compound.

9. The wavelength conversion material according to claim 1, wherein the quantum dot phosphor comprises a compound containing at least one of Cd or In.

10. The wavelength conversion material according to claim 1, wherein the cured product is in a form of a film.

11. The wavelength conversion material according to claim 1, further comprising a coating material that coats at least a portion of the cured product.

12. The wavelength conversion material according to claim 11, wherein the coating material has barrier properties against at least one of oxygen or water.

13. The wavelength conversion material according to claim 1, wherein a loss tangent (tan δ) of the cured product, measured under conditions of a frequency of 10 Hz and a temperature of 25° C. by dynamic viscoelasticity measurement, is from 0.4 to 1.5.

14. A backlight unit comprising the wavelength conversion material according to claim 1 and a light source.

15. An image display device comprising the backlight unit according to claim 14.

16. A curable composition comprising a (meth)allyl compound, a (meth)acryl compound, a photopolymerization initiator, and a quantum dot phosphor.

17. The curable composition according to claim 16, further comprising a thiol compound.

18. The curable composition according to claim 16, wherein the (meth)acryl compound includes a monofunctional (meth)acryl compound.

19. The curable composition according to claim 18, wherein the monofunctional (meth)acryl compound includes an alkyl (meth)acrylate having an alkyl group having from 1 to 18 carbon atoms.

20. The curable composition according to claim 19, wherein the alkyl (meth)acrylate having an alkyl group having from 1 to 18 carbon atoms includes at least one selected from the group consisting of methyl (meth)acrylate, n-butyl (meth)acrylate, isobutyl (meth)acrylate, 2-ethylhexyl (meth)acrylate, isononyl (meth)acrylate, n-octyl (meth)acrylate, lauryl (meth)acrylate and stearyl (meth)acrylate.

21. The curable composition according to claim 18, wherein the monofunctional (meth)acryl compound includes an alicyclic (meth)acrylate compound.

22. The curable composition according to claim 21, wherein the alicyclic (meth)acrylate compound includes at least one selected from the group consisting of cyclohexyl (meth) acrylate, dicyclopentanyl (meth)acrylate, isobornyl (meth)acrylate and methylene oxide adduct cyclodecatriene (meth) acrylate.

23. The curable composition according to claim 16, wherein the (meth)acryl compound includes a monofunctional methacrylate compound.

24. The curable composition according to claim 16, wherein the quantum dot phosphor comprises a compound containing at least one of Cd or In.
